(19) United States
(12) Patent Application Publication
(10) Pub. No.: US 2026/0014645 A1
(43) Pub. Date: Jan. 15, 2026

(54) CONTROL UNIT FOR ISSUING A LASER BEAM RELEASE IN A LASER SYSTEM

(71) Applicant: TRUMPF Laser- und Systemtechnik SE, Ditzingen (DE)

(72) Inventors: Axel Oberänder, Kirchheim am Neckar (DE); Martin Stein, Stuttgart (DE); Thomas Wahl, Sachsenheim (DE); Lucas Hillgemann, Grafenau (DE); Jörg Weber, Obersulm (DE)

(21) Appl. No.: 19/330,869

(22) Filed: Sep. 17, 2025

Related U.S. Application Data
(63) Continuation of application No. PCT/EP2024/056449, filed on Mar. 11, 2024.

(30) Foreign Application Priority Data
Mar. 20, 2023 (DE) 10 2023 106 968.3

(51) Int. Cl. B23K 26/08

(52) U.S. Cl. CPC B23K 26/0869

(57) ABSTRACT

A control unit for use in a laser system for working a workpiece by a laser beam is configured to capture, based on at least one translation axis position, a translational position of a working head which can be changed by a movement unit, capture, based on at least one rotation axis position, a rotational orientation of the working head which can be changed by the movement unit, and issue or revoke a laser beam release for an application of the laser beam to the workpiece. The laser beam release depends on a serial test of the translational position and the rotational orientation of the working head.

### CROSS REFERENCE TO RELATED APPLICATIONS

This application is a continuation of International Application No. PCT/EP2024/056449 (WO 2024/194071 A1), filed on Mar. 11, 2024, and claims benefit to German Patent Application No. DE 10 2023 106 968.3, filed on Mar. 20, 2023. The aforementioned applications are hereby incorporated by reference herein.

### FIELD

Embodiments of the present disclosure relate to a control unit for use in a laser system for working a workpiece by means of a laser beam, and to a laser system and a method for applying a laser beam to a workpiece.

### BACKGROUND

Laser systems, in particular multi-axis laser systems, have become an indispensable technology in many industries in recent years. They offer high precision and high flexibility, and enable materials to be processed, i.e., cut or welded, efficiently. Due to the high energy density of a laser beam of a generic laser system, it is necessary to equip the laser system with laser protection. This is intended to prevent the laser beam from hitting a region outside the working range thereof, which could damage a protective cabin and endanger persons in the surrounding region. Passive or active applications are used for laser protection. Passive laser protection is ensured, for example, by a protective cabin surrounding the laser system, which can withstand the energy input from the laser beam for a certain period of time. Active laser protection is provided by a sensor-equipped laser protection system and is known, for example, from the published patent application DE 10 2015 219 369 A1. This discloses a safety device for a laser system having a multi-axis manipulator. Further prior art of this type is known from the utility model DE 20 2005 007 140 U1 and the published patent applications US 2018/0113434A1 and DE 10 2012 216632 A1.

### SUMMARY

Embodiments of the present disclosure provide a control unit for use in a laser system for working a workpiece by a laser beam. The control unit is configured to capture, based on at least one translation axis position, a translational position of a working head which can be changed by a movement unit, capture, based on at least one rotation axis position, a rotational orientation of the working head which can be changed by the movement unit, and issue or revoke a laser beam release for an application of the laser beam to the workpiece. The laser beam release depends on a serial test of the translational position and the rotational orientation of the working head.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a side view of a laser system according to some embodiments;

FIG. 2 shows a further side view of a laser system according to some embodiments;

FIG. 3 shows a further side view of a laser system according to some embodiments with a position in which a laser beam release is issued and a position in which no laser beam release is issued;

FIG. 4 shows a further side view of a laser system according to some embodiments with a position in which a laser beam release is issued and a position in which no laser beam release is issued;

FIG. 5 shows a flowchart of a serial test according to some embodiments;

FIG. 6a shows a further side view of a laser system according to some embodiments in two-station operation, in a first operating state in which a release is issued; and

FIG. 6b shows the side view from FIG. 6a in a second operating state in which no release is issued or the release is revoked according to some embodiments.

### DETAILED DESCRIPTION

Embodiments of the present invention provide an improved control unit for use in a laser system for working a workpiece by means of a laser beam and a method for applying a laser beam to a workpiece.

Accordingly, a control unit for use in a laser system for working a workpiece by means of a laser beam is proposed. The control unit can have one or more control devices. A control device can consist of electronic modules that control or regulate a specific function of the laser system. The control unit is configured to capture, on the basis of at least one translation axis position, a translational position of a working head, which can be changed by means of a movement unit. The translational position can be specified in three-dimensional space using Cartesian coordinates x, y, z. It can therefore consist of an x-position, a y-position, and a z-position. Each of these positions can have its own translation axis position. The translational position of the working head can be captured using three translation axis positions. The movement unit can have a drive, such as a linear drive, which changes at least one, in particular three translation axis positions to move the working head, for example to a position intended for an intended working of the workpiece. The working head can be a laser cutting head or a laser welding head. For example, it can be moved into the translational position thereof using a slide. The working head can have a focusing optics with a focusing lens. This focuses the laser beam, which is connected to a laser source, such as a solid-state laser, via a deflection housing and a laser light cable.

The control unit is further configured to capture, on the basis of at least one rotation axis position, a rotational orientation of the working head which can be changed by means of the movement unit. The rotational orientation can be specified via an angular position about at least one rotation axis. The rotational orientation can be changed across two or three rotation axes to provide a multi-axis system, in particular a 5-axis laser system or a 6-axis laser system. Each of these rotation axis positions can be captured and provide the rotational orientation. The position and orientation of the working head consist of the translational position and the rotational orientation.

The control unit is further configured to issue or revoke a laser beam release for applying the laser beam to the workpiece, the laser beam release depending, in particular conclusively, on a serial, therefore two-stage, test of the translational position and the rotational orientation of the working head. The serial test can be carried out in two stages, first checking a first condition, such as the presence of a translational condition, and—if this is present—a second condition, such as the presence of a rotational condition. If the laser beam release ultimately depends on the translational position and the rotational orientation of the working head, the laser beam can be released solely based on the input variables translation axis position and rotation axis position. Serial testing can include active querying as well as passive evaluation. During active querying, the control unit is continuously informed about the translational position and, if necessary, the rotational orientation and issues a laser beam release depending thereon. During passive evaluation, the control unit is informed of the translational position and/or the rotational rotation at least when the at least one translation axis position and/or the at least one rotation axis position are in a predetermined range or have exceeded a certain value that is stored, for example, in the control unit. Depending thereon, a laser beam release can be revoked. Depending on the result of the translational position check, the serial test can require the rotational orientation check to be carried out or can be completed after the translational position test because the translational position alone determines whether or not a laser beam release should be issued.

The laser beam release can be a program command that the control unit sends to the laser to issue it permission to apply the laser beam to a position on the workpiece indicated by the working head or to revoke the permission to apply the laser beam to a position on the workpiece indicated by the working head. The indicated position on the workpiece can be captured via the translational position and the rotational orientation of the working head as well as via a workpiece geometry communicated to the control unit. The control unit can thus issue or revoke a laser beam release in response to the fact that the position and orientation of the working head have been communicated thereto on the basis of at least one translation axis position and at least one rotation axis position. For example, serial testing can be divided into three groups of cases: (i) If the translational position of the working head is, for example, outside a working region, this is communicated to the control unit using the corresponding translation axis position, and the control unit does not issue a laser beam release to the laser and the working head connected thereto regardless of the rotational orientation of the working head. (ii) However, if the translational position is within the working region and within a protected region, the rotational orientation must be checked to issue or revoke a laser beam release. The protected region can be adjusted depending on the laser power and/or a type of laser optics, a protective enclosure or protective cabin of the laser system, and/or an application of the laser system for working the workpiece. The protected region can represent an edge region of the working region, within which the rotational orientation must also be checked in addition to the translational position. (iii) If the translational position is within the working region and outside the protected region, the application of the laser beam is safe regardless of the orientation of the working head. Accordingly, the control unit issues a laser beam release, regardless of the rotational orientation of the working head. In this respect, a serial test takes place because the test of the rotational orientation depends on the result of the test of the translational position.

This ensures software-supported monitoring of the position and orientation of the working head. It anticipates when the laser beam is directed at regions outside the working region without resorting to laser-sensitive sensors, for example outside or inside the working region. This increases the safety of laser systems because the presence of a safety-impairing condition is detected and prevented before a laser beam can be harmfully incident outside the working region thereof. In addition, a robust and error-resistant system is provided, since laser beam release can be issued or revoked on the basis of the position and/or orientation. The control unit according to embodiments of the disclosure enables an efficient and streamlined laser system with a low hardware requirement for safe operation.

In one embodiment, the control unit is configured to check, during the serial test, a translational condition in which the translational position is within a predetermined translation range and a rotational condition in which the rotational orientation is within a predetermined rotation range, wherein the predetermined rotation range varies depending on the translational position. For example, a first value of a rotational orientation can receive a laser beam release at a first translational position, i.e., lie within the predetermined rotation range, and the same first value of the rotational orientation cannot receive a laser beam release at a second translational position, i.e., lie outside the predetermined rotation range. The laser beam release can only be issued when the translational condition and cumulatively the rotational condition are met. Because the rotational condition depends on the translational position, i.e., varies therewith, the working region is maximized and the space utilization is optimized. The translational position can be divided into three regions: (i) outside the working region, where no laser beam release is issued, (ii) inside the working region but also inside the protected region, where laser beam release is issued depending on the rotational orientation, (iii) inside the working region and outside the protected region, where laser beam release is issued regardless of the rotational orientation.

For example, if the control unit captures a translational position that is located at an outer edge of a working region, such as within the working region and within the protected region, the laser beam release is issued depending on the rotational orientation: If a rotational orientation, for instance about a rotation axis b, is inclined by 0°, for example, the indicated position of the working head is within the working region and outside the protected region, which is why the laser beam release is issued or is not revoked. If, however, the rotational orientation is inclined in an orientation away from the working region, for example −10°, the indicated position of the working head is within the working region and within the protected region and the laser beam release is not issued or is revoked accordingly. With the same values of the rotational directions and different translational positions, the laser beam release can vary. This dynamic adjustment of the laser beam release enables a high degree of flexibility in the position and orientation of the working head. In addition, the installation space of the laser system is minimized, which is particularly advantageous when the laser system comprises a plurality of working regions next to each other, such as in a two-station operation. The dynamic adaptation of this embodiment also enables an adaptable trade-off between i) the largest possible working space for the laser beam and (ii) the simplest possible query of the laser beam release. This also increases the safety of the issued laser beam release.

In one embodiment, the predetermined translation range and/or the predetermined rotation range is stored in the form of an array in a memory region of the control unit. An array can enable multiple values to be stored in one variable. Individual arrays and values defined therein, for example an array of the predetermined translation range, can be logically linked with other arrays and values defined therein, for example an array of the predetermined rotation range. A first array can be checked first and then a second array in an AND combination. Instead of an array, a safe software cam can also be used, which can be processed using safety logic. It is also possible to store the predetermined translation range and/or rotation range in the form of at least one lookup table. For example, the lookup table can list the rotational directions for the translational positions within the protected region for which a laser beam release must be issued.

When the working head assumes a corresponding position, it can be determined via a low-computing comparison with the array (or the safe software cam or the lookup table) whether a laser beam release should be issued or revoked. There can also be multiple arrays or multiple values within the same array depending on the different translational positions and/or the different operating factors, such as the laser power, the type of laser optics, the protective cabin present and/or the application of the laser system to process the workpiece. The number of arrays or values within the same array can determine the maximum working space within which the laser beam release is issued and the computing power required to issue a laser beam release. As the array size increases, the working space and with it the computing power required for laser beam release increase. The arrays can therefore be used to adapt the laser system's performance characteristics to suit specific applications.

In one embodiment, the predetermined translation range and/or the predetermined rotation range is determined in a training phase preceding an operating phase. The training phase can be carried out on the laser system itself or at least partly on a simulation. It is used to determine the positions and directions in which a laser beam release should or should not be issued. For example, for each translational position, a variety of rotational directions can be controlled to maximize the region for which a laser beam release is to be issued. The training phase can be used to determine the optimal ratio of working space to required computing power.

In one embodiment, the predetermined translation range and/or the predetermined rotation range depends on at least one of (i) a laser power, which can be, for example, between 3 and 8 KW, and/or a type of laser, such as a high-power solid-state laser, or a type of laser optics, (ii) a protective cabin of the laser system, (iii) an application of the laser system for working the workpiece, for example welding, such as deep penetration welding, and/or laser cutting and/or 3D laser working and/or (iv) optical parameters for beam shaping. The adaptability of the laser beam release to external parameters increases the flexibility of the control unit and the laser system.

In one embodiment, a capture communication between the movement unit and the control unit for capturing the translational position and the rotational orientation takes place via a capture path that is error-proof. An error-proof path is implemented using safe transmission technology and enables, in particular, safety-related motion monitoring and/or an error-proof programmable logic controller (PLC). It meets strict safety requirements. In particular, the error-proof path meets the strict safety requirements of (i) Safety Class 2 (Safety Integrity Level 2, SIL 2) in accordance with IEC 61508, (ii) Performance Level d (PL d) in accordance with DIN EN ISO 13849 1 and/or (iii) Category 3 in accordance DIN EN ISO 13849 1. The error-proof position capture can be implemented, for example, on a single channel using an encoder with a serial interface. The error-proof path takes place in safety communication and distinguishes itself from unsafe paths that exist in unsafe technology by detecting errors in the path itself and triggering an alarm if necessary. The capture communication therefore does not rely on an unsafe programmable logic controller (PLC), which increases the reliability thereof. The capture communication can take place between the movement unit and a dedicated control device within the control unit and can be independent of other paths. In this way, error-resistant communication of the translation axis position and the rotation axis position is enabled. This means that the highest safety standards can be met even without error-sensitive sensors.

In one embodiment, a release communication between the control unit and the movement unit for communicating an issued laser beam release takes place via a release path that is error-proof. The release communication therefore does not rely on any unsafe PLC, which increases the safety thereof. The release communication can take place between a dedicated control device within the control unit and the movement unit and can be independent of other paths. In this respect, a redundant control device can be provided within the control unit to minimize the probability of errors in the release communication.

In one embodiment, a movement communication takes place between the control unit and the movement unit for changing the translational position and the rotational orientation by means of a movement path, wherein the capture path and/or the release path is implemented independently of the movement path. The movement path can therefore be designed as a single-channel path and, unlike the capture path and/or the release path, can be designed using unsafe technology. For example, the motion path, the capture path, and/or the release path can each have their own control devices within the control unit so that they are independent of each other. The capture communication and the release communication can take place using safe technology, while the movement communication can be PLC- or NC-controlled using unsafe technology.

In one embodiment, the control unit is configured to capture the translational position via at least one software cam of the translation axis position and/or to capture the rotational orientation via at least one software cam of the rotation axis position. A software cam is a position of a machine axis stored in the control unit, such as at least one, in particular each, translation and rotation axis to which a function is assigned. When the position of the machine axis is reached, a corresponding signal is sent. For example, software cams can be used for the at least one, in particular each, translation and rotation axis as a path limitation. Reaching an axis position identified by the software cam can trigger a rotation stop function within the control unit, whereupon further rotation of the machine axis by the movement unit or the working head is prevented. In addition, the software cams can be used for laser beam release. Reaching an axis position identified by the software cam triggers a laser beam release stop function within the control unit, whereupon no laser beam release is issued or the laser beam release is revoked. The software cams can be set and activated according to the translational condition and/or the rotational condition.

In one embodiment, the control unit comprises a first control device for controlling the movement unit and/or the working head and a second control device for issuing or revoking the laser beam release, wherein the first control device is independent of the second control device. This increases the redundancy of the laser system and thus also the operational reliability. The individual control devices can communicate with each other.

Embodiments of the present disclosure further relate to a laser system for working a workpiece by means of a laser beam, having a control unit according to embodiments of the disclosure and a working head for aligning the laser beam onto the workpiece, wherein the working head assumes the translational position determined by at least one translation axis position and the rotational orientation determined by at least one rotation axis position, and wherein the working head is configured to apply the laser beam only with a laser beam release. The laser system also has a movement unit for changing the translational position and the rotational orientation. The laser system can have the features disclosed in connection with the control unit. In one embodiment, the translation axis position of the laser system is determined by three linear axes and/or the rotation axis position is determined by one, two, or three rotation axes. Such a four-, five-, or six-axis laser system is a 3D laser system that can variably move the working head. The control unit according to embodiments of the disclosure ensures that the laser system is operated using safe technology, for example by using software cams.

In one embodiment, the laser system has a first working region for working a first workpiece and a second working region for working a second workpiece to realize two-station operation. In this case, the movement unit is designed to move the working head between the first working region and the second working region. For example, a workpiece can first be worked in the first working region and then the working head can be moved to the second working region to work a second workpiece while, for example, a workpiece is being exchanged in the first working region. This guarantees time-efficient working for high quantities. A separating device is provided between the first working region and the second working region to shield the operator from laser radiation. The separating device serves to shield a laser beam directed from the first working region to the second working region. The separation device can be provided in addition to and within the protective cabin surrounding the laser system.

In one embodiment, the separating device is designed as a partition wall, the height of which is, at least in sections, sufficiently large to provide the shielding between the first and the second working region, and sufficiently small to enable the movement of the working head between the first working region and the second working region. The partition wall can have a movable separating flap. This can be extendable and retractable in a region in which the working head moves between the first working region and the second working region. When extended, it can be flush with the top edge of the partition wall. When retracted, it provides a recess within the partition wall through which the working head moves when moving from one working region to the other. The separating flap therefore enables, on the one hand, a maximum area of the partition wall for maximum safety, and, on the other hand, a flexible movement of the working head in two-station operation.

In one embodiment, a first scanner field is defined for the first working region and a second scanner field is defined for the second working region. The respective scanner field defines the region that must be protected against the laser beam from the adjacent working region, for example because an operator might be present there when changing the workpiece. The distance from the scanner field to the potential laser radiation can be designed in such a way that a switch-off time of the laser beam is taken into account. The control unit is configured to check during the serial test whether, when the working head is in the first working region, the laser beam is directed onto the second scanner field and/or when the working head is in the second working region, the laser beam is directed onto the first scanner field, to only issue a laser beam release if the laser beam is not directed at the corresponding scanner field. The control unit can therefore be configured not to issue or to revoke the laser beam release for applying the laser beam to the workpiece when the working head is in the first working region and the laser beam is directed at the second scanner field or when the working head is in the second working region and the laser beam is directed at the first scanner field. The scanner field and the partition wall can be used to increase safety in two-station operation.

Embodiments of the disclosure also relate to a method for applying a laser beam to a workpiece, having the following steps:
capturing, on the basis of at least one translation axis position, a translational position of a movement unit and capturing, on the basis of at least one rotation axis position, a rotational orientation of the movement unit. The capture can be carried out continuously or only when the translation axis position and/or the rotation axis position are in a certain range; for example, when they exceed or fall below a certain value. Furthermore, the translational positions of three translation axes, such as axes for linear movement, and the rotational orientation of two or three rotation axes can be captured.
checking a translational condition, whether the translational position lies within a predetermined translation range. The check can be designed in such a way that it captures presence within the release region or in such a way that it captures leaving a release region. The former involves active querying, while the latter is a passive evaluation, as explained above in connection with the control unit.
checking a rotational condition, whether the rotational orientation is within a predetermined rotation range. The rotational condition can be checked cumulatively after the translational condition. In particular, it can only be checked if the translational condition gives rise thereto, as explained above in connection with the control unit.
issuing a laser beam release when the translational condition and the rotational condition are present, wherein the laser beam can only be applied to the workpiece with the laser beam release. In this way, the working head is not able to apply a laser beam to the workpiece if there is no laser beam release or if laser beam release has been revoked.

This method enables software-supported monitoring of the position and orientation of the working head. It anticipates-analogously to the control unit-when the laser beam is directed at regions outside the working region, without resorting to laser-sensitive sensors outside or inside the working region. This increases the safety of laser systems because the presence of a safety-impairing condition is detected and prevented before a laser beam can be harmfully incident outside the working region thereof. In addition, a robust and error-resistant system is provided, since laser beam release can be issued or revoked on the basis of the position and/or orientation. The process enables an efficient and lean laser system with a low hardware requirement for safe operation.

In one embodiment of the method, the presence of the rotational condition varies with the translational position. As the rotational condition depends on the translational position, the working region is maximized and space utilization is optimized. The translational position can be divided into three regions: (i) outside the working region, where no laser beam release is issued, (ii) within the working region but also within the protected region, where a laser beam release is issued depending on the rotational orientation, (iii) within the working region and outside the protected region, where a laser beam release is issued regardless of the rotational orientation, as explained above in connection with the control unit. The method according to embodiments of the disclosure can be carried out on the laser system according to embodiments of the disclosure with the control unit. The features, effects, and advantages disclosed above in connection with the control unit or the laser system can therefore be applied accordingly to the method insofar as they apply accordingly to method steps.

Preferred exemplary embodiments are described below with reference to the figures. In this case, elements that are the same, similar, or have the same effect are provided with identical reference symbols in the different figures, and a repeated description of these elements is omitted in some instances to avoid redundancies.

FIG. 1 schematically shows a laser system 1 for working a workpiece using a laser beam. The laser system 1 has a control unit 100 which comprises one or more control devices which are at least partially connected to one another. A movement unit 2 is configured to move a working head 3, thus changing the translational position thereof, which can be determined using Cartesian coordinates x, y, z, and the rotational orientation thereof, which can be determined via angular spans about rotation axes a, b, c. The working head 3 can, for example, comprise a laser optics. It is used, for example, to focus laser radiation supplied via a fiber optic cable onto the workpiece or to image it thereonto to process the workpiece using the laser radiation. A release of the laser beam for exposure of the workpiece to the laser beam can be provided to ensure the safety of the surrounding regions. Regions are understood here as spatial regions.

The working head 3 only applies the laser beam to the workpiece when there is a laser beam release. For example, a laser beam release can be actively issued before each laser beam ignition. Alternatively, a laser beam release can be revoked in the event that the laser beam is applied to an impermissible region. The laser beam release for the application of the laser beam to the workpiece depends on a serial test of the translational position and the rotational position of the working head 3.

The control unit 100 captures a translation axis position of at least one, in particular each of the x-, y-, z-axes which determine the translational position. A pair of software cams is provided in at least one, in particular each x-, y-, z-axis. A software cam specifies a position of a machine axis to which a specific function is assigned. This allows the control unit to prevent further movement or rotation of the axis when the translation axis position reaches a software cam. Accordingly, the control unit 100 also captures a rotation axis position of at least one, in particular each of the a-, b-, c-axes that determine the rotational orientation. A pair of software cams is provided in at least one, in particular each a-, b-, c-axis.

The serial test of the translational position and the rotational orientation first checks for the presence of a translational condition in which the translational position is within a predetermined translation range. The translational condition can be checked for each of the three translation axes x, y, z. These checks of the translational condition of the translation axes x, y, z can be run parallel to each other. Alternatively, they can run serially, so that first the translational condition of the x-axis is checked, then the translational condition of the y-axis, and then the translational condition of the z-axis. The check of the translational condition can be divided into three case groups, which are shown below using the x-axis. The theory of these case groups can be applied analogously to the y-axis and the z-axis.

At x=0, the working head 3 is in the central position. This position x=0 is within the working region and outside a protected region. The protected region can represent an edge region of the working region, within which the rotational orientation must also be checked in addition to the translational position. The protected region can be adjusted in the control unit. The translational condition of the x-position for the laser beam release is fulfilled because the translational position is within the working region. If the translational condition of the y-position and the z-position is also fulfilled such that the respective position is within the working region and outside the protected region, the control unit 100 issues a laser beam release regardless of the rotational orientation of the working head 3 (see also FIG. 5).

At x=+/−x1 a protected region of the x-position begins. This extends to the position x=+/−x2. If the working head 3 is within the protected region of the x-position, a rotational condition is checked. The presence of a rotational condition in which the rotational orientation is within a predetermined rotation range is checked. The rotational condition is checked serially after the translational condition (see also FIG. 5).

If x>|x2| the working head is outside the protected region and outside the working region. Regardless of the other conditions, i.e., the translational condition of the y-axis and the z-axis as well as the rotational condition, no laser beam release is issued outside the working region (see also FIG. 5).

The rotational orientation is checked serially after the translational position. If all three translational positions, i.e., the x-position, the y-position, and the z-position, fall into the above case group (i), the rotational orientation is not checked because the working head 3 is located within the working region and outside the protected region and therefore a laser beam release is issued anyway. If at least one of the translational positions falls into the above case group (iii), the rotational orientation is also not checked because the working head 3 is located outside the working region and therefore no laser beam release is issued anyway. However, if the translational position falls into case group (ii) above, the rotational orientation check is required to issue or revoke laser beam release. Depending on the translational position of the working head 3 within the above case group (ii), i.e., within the protected region, the rotational orientation at which a laser beam release is issued or revoked varies. In this respect, a serial test takes place because the test of the rotational orientation depends on the result of the test of the translational position.

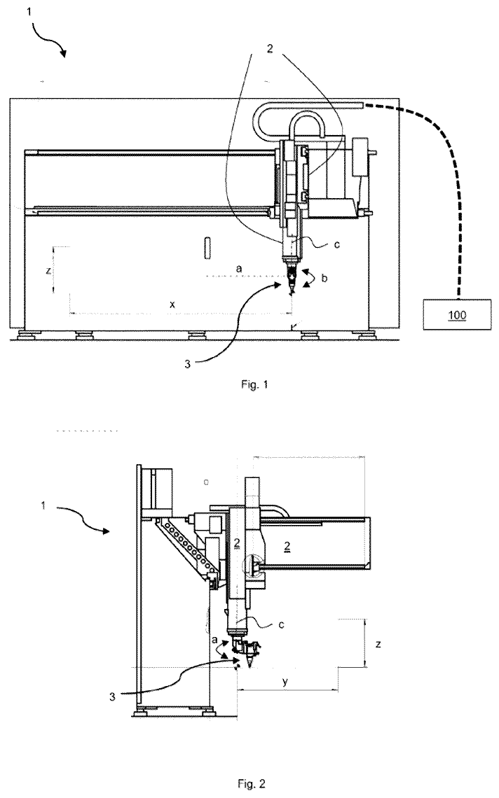

FIG. 2 shows the laser system 1 from a different direction. The working head 3 has an offset along the y-direction. The laser system 1 is a 3D laser system. The working head 3 can be moved translationally in all three spatial directions x, y, z by means of the movement unit 2, for example by means of a linear drive. In addition, the working head 3 can be rotated by means of the movement unit 2 about rotation axes, for example about three rotation axes a, b, c or about two rotation axes b, c. The laser system 1 thus achieves maximum flexibility in the application of the laser beam to the workpiece, such as laser welding and/or laser cutting. This allows for versatile workpiece geometries to be worked into flexible shapes.

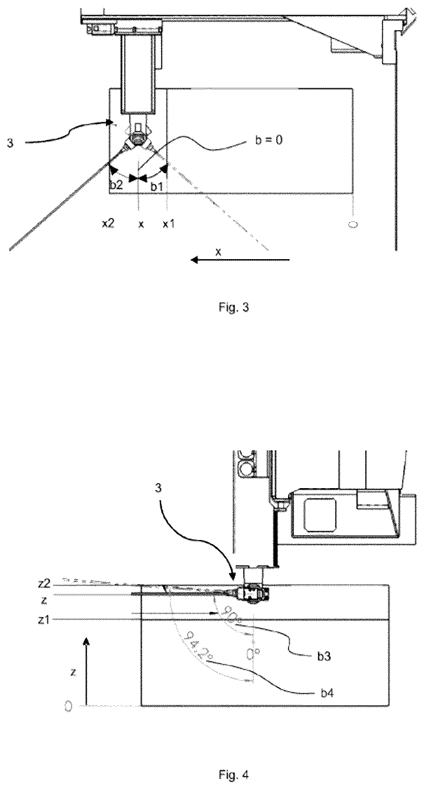

FIG. 3 shows an example of how the laser beam release in the above case group (ii), i.e., within the protected region, depends on the rotational orientation of the working head 3. A translational x-position of the working head 3 lies between a value x1 and x2. The working head 3 is therefore located in the x-direction within the working region and within the protected region. If the working head 3 assumes the angle b1 in the rotational orientation about the rotation axis b, which protrudes from the plane of the drawing, the laser beam reaches the working region. Accordingly, for this case where b=b1, a laser beam release is issued or is not revoked. However, if the working head 3 assumes the angle b2 in the rotational orientation about the rotation axis b, the laser beam is outside the working region. Accordingly, for this case where b=b2, a laser beam release is not issued or is revoked. In a third case, the working head 3 could also assume the angle b=0 in the rotational orientation about the rotation axis b. In this case, the laser beam runs completely within the protected region. In this case, a laser beam release can optionally be issued. For example, the critical values for x and b can be determined in such a way that when the laser beam is incident on the protective cabin, a previously defined minimum service life of the protective cabin is not undercut.

In this way, the application range of the laser beam is increased because laser beam release can also be issued within the protected region due to the serial test depending on the rotational orientation. The position x=x1 represents the x-software cam. From this position, on the basis of the translation axis position of the x-axis, the control unit 100 is informed that the working head 3 is located within the protected region. The software cam is therefore not only used for path limitation, but also for the laser beam release. Corresponding to the x-axis, all other axes of the multi-axis laser system 1 also have corresponding software cams that are used for laser beam release. In one embodiment, the z-axis can also be designed free of software cams. If the working head 3 is moved by the movement unit 2 along the x-direction into a range between x=0 and x<x1, the above case group (i) is relevant, in which a laser beam release is issued regardless of the rotational orientation. If the working head 3 is moved by the movement unit 2 along the x-direction into a range x>x2, the above case group (iii) is relevant, in which a laser beam release is not issued regardless of the rotational orientation.

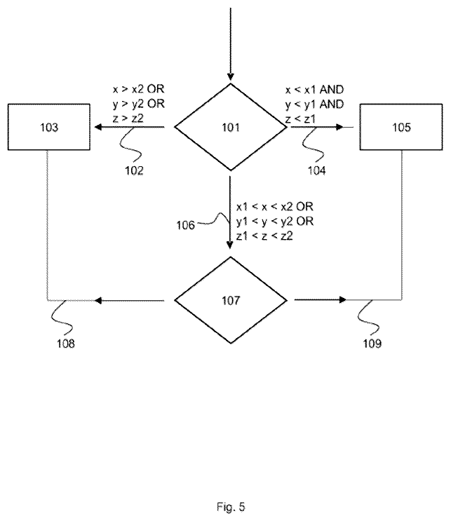

FIG. 4 shows the laser system 1 in another operating state. The working head 3 is located along the z-translation axis at a position z which lies within the positions z1 and z2, thus within the protected region of the z-axis. In this position, the above case group (ii) is relevant, in which the rotational orientation must be checked for a laser beam release. The illustration shows the working head 3 pivoting about the b-axis. If the working head 3 rotates by b3=90° in the z-position shown, the laser beam is within the protected region and therefore receives a laser beam release. However, if the working head 3 rotates by b4 equal to 94.2° in the z-position shown, the laser beam is outside the protected region and therefore does not receive a laser beam release. The rotational orientation b3=90° represents a software cam of the b-axis. From this position, on the basis of the rotation axis position of the b-axis, the control unit 100 is informed that the working head 3 is located within the protected region. The software cam is therefore not only used for path limitation, but also for the laser beam release. If the working head 3 is moved by the movement unit 2 along the z-direction into a range between z=0 and z<z1, the above case group (i) is relevant, in which a laser beam release is issued regardless of the rotational orientation. If the working head 3 is moved by the movement unit 2 along the z-direction into a range z>22, the above case group (iii) is relevant, in which a laser beam release is not issued regardless of the rotational orientation.

FIG. 5 shows a flowchart of the serial test. In field 101 a translational condition is checked. When checking the translational condition, it is checked whether a translational position of the working head 3 is within a predetermined translation range. This check can be carried out in parallel for each translational direction x, y, z, in particular it can also be performed only for the x-direction or only for the x- and y-direction. Alternatively, this check can serially check first the first, then the second, then the third translational direction. Depending on the result for the translational condition, further steps can follow. If at least one of the translational positions x, y, z is outside the working region, i.e., greater than x2 or y2 or z2, step 102, no laser beam release is issued, field 103. If, however, every translational position x, y, z is within the working region and outside the protected region, i.e., smaller than x1 or y1 or z1, step 104, a laser beam release is issued, field 105. For steps 102, 104, no check of the rotational orientation is required because the translational position already determines whether or not a laser beam release should be issued. The serial test is now complete. If at least one of the translational positions x, y, z is within the protected region, i.e., between x1 and x2 or y1 and y2 or z1 and z2, step 106, a rotational condition must be checked, field 107. Depending on which of the three translational positions x, y, z is within the protected region and depending on which translational position value the respective translational position takes within the protected region, the predetermined rotation range within which the rotational orientation can lie to fulfill the rotational condition will vary. The rotation range, which varies with the translational position, is stored, for example, as an array in a memory region of the control unit 100. It can be determined in a training phase preceding the operating phase of the control unit 100, and can vary depending on external factors such as the laser power and/or the type of laser optics, a protective cabin of the laser system and/or an application of the laser system for working the workpiece. The rotational orientation check either shows that the rotational condition is not met, step 108, and therefore no laser beam release is issued, field 103. Alternatively, the rotational orientation check shows that the rotational condition is met, step 109, and therefore a laser beam release is issued, field 105. If, for example, the working head 3 assumes a new translational position and rotational orientation and the control unit 100 captures this position and orientation on the basis of the respective axis positions, the sequence from FIG. 5 can start again from the beginning.

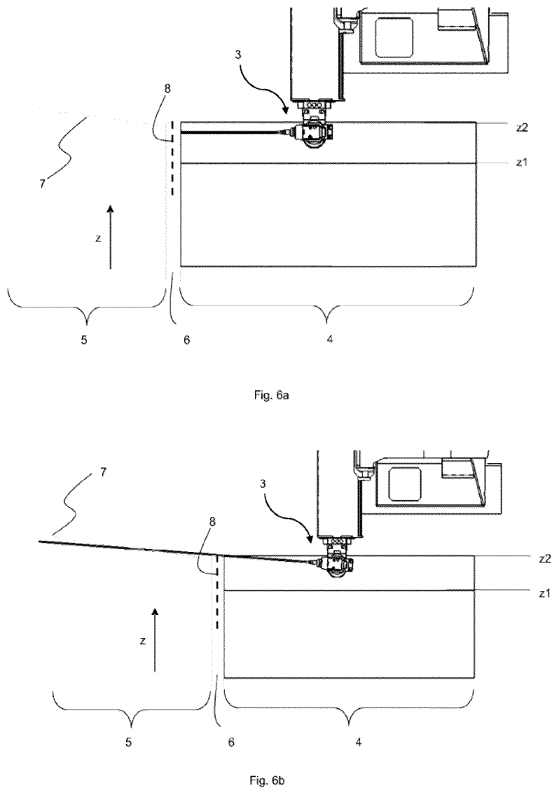

FIGS. 6a and 6b show the laser system 1 in two-station operation. In two-station operation, the laser system 1 has a first working region 4 and a second working region 5. At least one workpiece can be worked in each working region 4, 5. A partition wall 6 is arranged as a separating device between the first working region 4 and the second working region 5. The working head 3 can be moved between the first working region 4 and the second working region. In the state shown in FIG. 6a, the working head 3 is located along the z-translation axis at a position z which lies within the positions z1 and z2, thus within the protected region of the z-axis. In this position, the above case group (ii) is relevant, in which the rotational orientation must always be checked for a laser beam release. In two-station operation, in addition to the rotational orientation, another criterion can be checked during the serial test, namely whether the laser beam is directed onto an adjacent scanner field 7.

In FIG. 6a, the working head 3 assumes a rotational orientation such that the laser beam is directed onto the partition wall 6. The laser beam therefore does not reach the adjacent scanner field 7, which is why a temporary laser beam release can be issued. In the operating state shown in FIG. 6b, the working head 3 is still arranged within the protected region of the z-axis. The rotational orientation is such that the laser beam extends beyond the partition wall 6 into the adjacent scanner field 7. In this case, a laser beam release cannot be issued or can be revoked within the scope of the serial test. This guarantees that in two-station operation no laser beam reaches the currently working-free working region.

In the two-station operation, a laser beam emanating from the working head 3 can be incident on the partition wall 6 within the first working region 4. In this way, the laser beam does not enter the scanner field 7 of the adjacent, second working region 5, and a laser beam release can be issued. The partition wall 6 can have a movable separating flap 8 in the region in which the working head 3 moves between the first working region 4 and the second working region 5. This is extended in an operating state in which the working head 3 is in the first working region 4 or the second working region 5 and thus causes a maximum area of the partition wall 6. In an operating state in which the working head 3 moves between the working regions 4, 5, the separating flap 8 is retracted and thus releases an area that enables the working head 3 to move between the first working region 4 and the second working region 5.

In FIG. 6b, the separating flap 8 is extended as in FIG. 6a, so that the area of the partition wall 6 is maximized. In FIG. 6b, the working head 3 assumes a position such that the laser beam passes over the partition wall 6 with the separating flap 8 extended from the first working region 4 into the second working region 5. The laser beam enters the second scanner field 7, so that, as described above, no laser beam release can be issued. In this way, in two-station operation, the greatest possible flexibility of the position and orientation of the working head 3 is combined with the greatest possible safety.

Insofar as applicable, all individual features presented in the exemplary embodiments can be combined with one another and/or interchanged.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Laser system
2 Movement unit
3 Working head
4 First working region
5 Second working region
6 Partition wall
7 Scanner field
8 Separating flap
100 Control unit
101-109 Test steps and test results of the sequential test
x, y, z Translation axes
a, b, c Rotation axes
b1-b4 Rotational directions about the b-axis

1. A control unit for use in a laser system for working a workpiece by a laser beam, the control unit being configured to:
capture, based on at least one translation axis position, a translational position of a working head which can be changed by a movement unit;
capture, based on at least one rotation axis position, a rotational orientation of the working head which can be changed by the movement unit; and
issue or revoke a laser beam release for an application of the laser beam to the workpiece, the laser beam release depending on a serial test of the translational position and the rotational orientation of the working head.

2. The control unit according to claim 1, being further configured to
check, during the serial testing, a translational condition in which the translational position is within a predetermined translation range, and a rotational condition, in which the rotational orientation is within a predetermined rotation range, wherein the predetermined rotation range varies depending on the translational position.

3. The control unit according to claim 2, wherein
the predetermined translation range and/or the predetermined rotation range is stored in a form of an array in a memory region of the control unit.

4. The control unit according to claim 2, wherein
the predetermined translation range and/or the predetermined rotation range is determined in a training phase prior to an operational phase.

5. The control unit according to claim 1, wherein
the predetermined translation range and/or the predetermined rotation range is dependent on at least one of
a laser power and/or a type of laser optics,
a protective cabin of the laser system, and/or
an application of the laser system for working the workpiece.

6. The control unit according to claim 1, wherein
a capture communication takes place between the movement unit and the control unit for capturing the translational position and the rotational orientation by a capture path which is error-proof.

7. The control unit according to claim 1, wherein
a release communication takes place between the control unit and the movement unit for communicating the laser beam release by a release path which is error-proof.

8. The control unit according to claim 6, wherein
a movement communication takes place between the control unit and the movement unit for changing the translational position and the rotational orientation by a movement path,
wherein the capture path is implemented independently of the movement path.

9. The control unit according to claim 1, being configured to
capture the translational position via at least one software cam of the translation axis position and/or to capture the rotational orientation via at least one software cam of the rotation axis position.

10. The control unit according to claim 1, comprising
a first control device for controlling the movement unit and/or the working head, and a second control device for issuing or revoking the laser beam release, wherein the first control device is independent of the second control device.

11. A laser system for working a workpiece by a laser beam, the laser system comprising:
the control unit according to claim 1;
the working head for orienting the laser beam onto the workpiece, the working head assuming a position determined by the translational position determined from the at least one translation axis position and the rotational orientation determined by the at least one rotation axis position, and the working head being configured to apply the laser beam only with the laser beam release; and
the movement unit for changing the translational position and the rotational orientation of the working head.

12. The laser system according to claim 11, wherein
the translation axis position is determined by three linear axes and/or the rotation axis position is determined by two or three rotation axes.

13. The laser system according to claim 11, comprising:
a first working region for working a first workpiece and a second working region for working a second workpiece, wherein the movement unit is configured to move the working head between the first working region and the second working region, and
a separating device for partial shielding between the first working region and the second working region.

14. The laser system according to claim 13, wherein
the separating device is configured as a partition wall, a height of the partition wall is at least in sections large enough to provide screening between the first working region and the second working region and is sufficiently small to enable movement of the working head between the first working region and the second working region, wherein the partition wall has a movable separating flap.

15. The laser system according to claim 13, wherein
a first scanner field is defined for the first working region and a second scanner field is defined for the second working region,
wherein the control unit is configured to check, during the serial test, when the working head is in the first working region, whether the laser beam is directed onto the second scanner field, and only issue the laser beam release if the laser beam is not directed onto the second scanner field, and
wherein the control unit is configured to check, during the serial test, when the working head is in the second working region, whether the laser beam is directed onto the first scanner field, and only issue the laser beam release if the laser beam is not directed onto the first scanner field.

16. A method for applying a laser beam to a workpiece, the method comprising:
capturing, based on at least one translation axis position, a translational position of a movement unit, and
capturing, based on at least one rotation axis position, a rotational orientation of the movement unit;
checking a translational condition of whether the translational position lies within a predetermined translation range;
checking a rotational condition of whether the rotational orientation is within a predetermined rotation range; and
issuing a laser beam release when the translational condition and the rotational condition are present, wherein the laser beam is applied to the workpiece only with the laser beam release.

17. The method according to claim 16, wherein
the presence of the rotational condition varies with the translational position.
